(19) United States
(12) Patent Application Publication
(10) Pub. No.: US 2023/0106358 A1
(43) Pub. Date: Apr. 6, 2023

(54) SOLID MATERIAL HAVING AN OPEN MULTIPLE POROSITY, COMPRISING A GEOPOLYMER AND SOLID PARTICLES, AND METHOD FOR THE PREPARATION THEREOF

(71) Applicants: COMMISSARIA À L'ÉNERGIE ATOMIQUE ET AUX ÉNERGIES ALTERNATIVES, Paris (FR); ORANO RECYCLAGE, Chatillon (FR)

(72) Inventors: Alban Gossard, Avignon (FR); Agnès Grandjean, Saint-Marcel De Careiret (FR); David Lambertin, Orange (FR); Nicolas Fabregue, Montpellier (FR)

(21) Appl. No.: 17/759,569

(22) PCT Filed: Jan. 25, 2021
(86) PCT No.: PCT/FR2021/050126

§ 371 Date: Jul. 27, 2022

(30) Foreign Application Priority Data
Jan. 28, 2020 (FR) FR2000821

(51) Int. Cl. B01J 20/18; B01J 20/28; B01J 39/02; B01J 39/14; B01J 47/018; B01J 47/014; B01J 20/30; G21F 9/12

(52) U.S. Cl. CPC B01J 20/183; B01J 20/2803; B01J 20/3042; B01J 20/3085; B01J 20/28016; B01J 20/28045; B01J 39/02; B01J 39/14; B01J 47/014; B01J 47/018; G21F 9/12

(57) ABSTRACT

Solid material having an open multiple and at least partially interconnected porosity, comprising an inorganic matrix made of a microporous and mesoporous geopolymer, in which at least partially interconnected open macropores delimited by sides or walls made of microporous and mesoporous geopolymer are defined, and particles of at least one solid compound different from the geopolymer being distributed in the macropores and/or in the sides or walls. Method for preparing said material. Method for separating at least one metal or metalloid cation from a liquid medium containing it, wherein said liquid medium is placed in contact with the material.

### TECHNICAL FIELD

The invention relates to a solid material having an open multiple porosity, also referred to as a material having a hierarchical and open porosity, comprising a geopolymer and solid particles distributed in the porosity.

More specifically, the invention relates to a solid material, having an open multiple porosity comprising a mineral, inorganic matrix, made of a microporous and mesoporous geopolymer, wherein at least partially interconnected open macropores defined by sides or walls made of microporous and mesoporous inorganic geopolymer are defined, and particles of at least one solid compound different, distinct, separate from the geopolymer being distributed in the macropores and/or in the sides or walls.

The matrix can also be referred to as “skeleton”.

The particles may in particular be active particles particularly particles of an inorganic solid metal cation exchanger compound, particles of an adsorbent, or particles of a catalyst.

The material according to the invention may particularly be in the form of a monolith.

The invention also relates to the method for preparing said material.

The invention may be applied in multiple fields, such as the fields of catalysis, metallic cation separation, or extraction on a solid phase by integrating particles of a selective adsorbent such as a zeolite.

The invention may more specifically be applied in the field of the treatment of effluents, particularly liquid effluents, and in particular of the treatment of radioactive liquid effluents, with a view particularly to removing metal cations, such as strontium cations, therefrom.

The present invention therefore also relates to a method for separating metal cations, particularly radioactive or toxic metal cations, contained in a medium, in particular a liquid medium, using said material.

### PRIOR ART

Methods using fixed beds require the development of materials having a multiple porosity, to optimise the transport properties in respect of ions or molecules of interest, and of sufficient size to serve as a bed while limiting head losses as much as possible. These materials having a multiple porosity are particularly macroporous materials, and they comprise active sites consisting of nanometric, submicronic or micronic active particles in the porosity thereof.

The preparation of these porous materials comprising nanometric, submicronic or micronic active particles in the porosity thereof can, according to a first method, be performed by granulation from nanometric, submicronic or micronic active particles obtained elsewhere and an inorganic binder.

The whole is then compacted cold and the binder provides the powder mixture with cohesion. The binder can be used dry for direct compression methods or in aqueous media for wet granulation methods. For the wet granulation method, the nanometric, submicronic or micronic active particles are suspended with the binder which will ensure cohesion, often followed by extrusion or heat treatment such as drying, or sintering. The most frequently used inorganic binders are clay-based. This method is industrial and simple. It can also be adapted to any type of particles. However, it does not make it possible to obtain controlled porosity of the material which then has poor transport properties (hydrodynamic and diffusion) for fixed bed applications. Furthermore, the “tablets” thus obtained have a low mechanical strength [1].

The preparation of these porous materials comprising nanometric, submicronic or micronic active particles in the porosity thereof can, according to a second method, be performed by transforming porous materials obtained elsewhere, for example porous silicas such as silica gel, porous glass, silicas obtained with the sol-gel process.

This second method consists of having the substrate, the porosity whereof is well controlled, undergo a chemical treatment, in order to obtain the properties of the nanometric, submicronic or micronic particles sought [2-3].

This method is difficult to transpose to all types of active particles because each type of particle has a different composition, which therefore requires a specific treatment. This method is complex and requires several steps, which therefore makes it difficult to transpose industrially. Furthermore, it can result in clogging of the porosity and therefore in poor accessibility to the active sites.

The preparation of these porous materials comprising nanometric, submicronic or micronic active particles in the porosity thereof can, according to a third method, be performed by functionalising porous materials. This method consists of pre-functionalising a porous material acting as a “skeleton” and then growing an active material step by step [4-5] in the structure of the skeleton from the pre-functionalised graft.

Here again, this method is complex, requires several steps, and is difficult to transpose to any type of particles. It can also result in clogging of the pores.

The preparation of these porous materials comprising nanometric, submicronic or micronic active particles in the porosity thereof can, according to a fourth method, be performed by impregnating a substrate porous material with a suspension containing the nanometric, submicronic or micronic active particles [6-7].

This method is simple to carry out but requires several impregnation steps. These impregnation steps are complex to manage because, on one hand, they can result in clogging of the pores of the substrate porous material and, on the other, they do not allow perfect control of the quantity of particles inserted in the substrate, or the homogeneity of the insertion of the particles in the pore network. Finally, poor adhesion of the particles on the substrate is sometimes observed, capable of inducing a release of the active particles during the use of the material in fixed-bed effluent treatment operations. Furthermore, this type of synthesis can result in materials of low mechanical strength [6].

The preparation of these porous materials comprising nanometric, submicronic or micronic active materials in the porosity thereof can, according to a fifth method, be performed using oil-in-water emulsions comprising nanometric or submicronic active particles, the emulsion being stabilised either by the presence of a surfactant, or by the active particles (Pickering type emulsion), or by the combination of the two. An inorganic oxide precursor in the aqueous phase makes it possible to add cohesion to the mixture by forming a skeleton, once the oil phase has been extracted [8-9]. This method requires the skeleton to consist of an oxide (use of silica very predominantly), which involves a sol-gel type synthesis that is complex to control, using relatively expensive precursors (alkoxides), and difficult to industrialise.

Furthermore, this method is limited to the insertion of active particles of small size (a few hundred nm at most), which can be very difficult to synthesise for some categories of active particles, and which can be difficult to manage industrially.

Finally, the alveolar porous structure of the materials obtained does not give them good hydrodynamic transport properties for fixed bed applications, potentially making the accessibility of the effluent to be treated to a portion of the active particles incorporated in the material skeleton difficult.

Therefore, in respect of the above, there is still an unmet need for a material having a multiple porosity particularly for a material having interconnected macroporosity which is mechanically robust and which can incorporate active particles homogeneously, and in such a way that these active particles are readily accessible to an effluent circulating in said macroporosity, in any case more accessible than in the materials of the prior art.

There is also a need for such a material which can have a wide variety of shapes and sizes for example from a millimetre to several tens of centimetres.

A first aim of the present invention is, inter alia, that of meeting such a need for such a material.

The aim of the present invention is furthermore that of providing such a material which does not have the drawbacks, limitations and disadvantages of the materials of the prior art, particularly of the materials described in the prior art documents cited above, and which solves the problems of these materials.

There is furthermore a need for a method for preparing such a material, which is reliable, with a limited number of steps, which is versatile and which can be adapted to all sorts of active particles regardless of the nature and size thereof (for example nanometric, micronic or submicronic). In particular, this method must be simple to implement in order to be reproducible and to be capable of being easily transposed to an industrial scale.

A second aim of the present invention is, inter alia, that of meeting such a need for such a method.

### DESCRIPTION OF THE INVENTION

The first aim described above, and others, are achieved, according to the invention with a solid material having an open multiple and at least partially interconnected porosity, comprising a (inorganic) matrix made of a microporous and mesoporous geopolymer, in which (matrix) at least partially interconnected open macropores delimited by sides (surfaces, faces) or walls made of microporous and mesoporous geopolymer are defined, and particles of at least one solid compound different, separate, distinct from the geopolymer being distributed in the macropores and/or in the sides or walls.

The term “geopolymer” or “geopolymer matrix or skeleton” denotes within the scope of the present invention a solid and porous material in the dry state, obtained following the hardening of a mixture containing finely ground materials (i.e. generally an alumino-silicate source) and a saline solution (i.e. an activation solution), said mixture being capable of setting and hardening over time. This mixture can also be referred to using the terms “geopolymeric mixture”, “geopolymeric composition” or “geopolymer paste”. The hardening of the geopolymer is the result of the dissolution/polycondensation of the finely ground materials of the geopolymeric mixture in a saline solution such as a high-pH saline solution (i.e. the activation solution).

More specifically, a geopolymer or geopolymer matrix or skeleton is an amorphous alumino-silicate inorganic polymer. Said polymer is obtained from a reactive material essentially containing silica and aluminium (i.e. the alumino-silicate source), activated by a strongly alkaline solution (activation solution), the solid/solution mass ratio in the formulation being low. The structure of a geopolymer is composed of a Si—O—Al lattice formed of tetrahedrons of silicates (SiO₄) and aluminates (AlO₄) bonded at the apexes thereof by oxygen atom sharing. Within this lattice are one or more charge compensating cation(s) also known as compensation cation(s) which make it possible to compensate the negative charge of the AlO₄⁻ complex. Said compensation cation(s) is (are) advantageously chosen in the group consisting of alkali metals such as lithium (Li), sodium (Na), potassium (K), rubidium (Rb) and caesium (Cs), alkaline-earth metals such as magnesium (Mg), calcium (Ca), strontium (Sr) and barium (Ba) and mixtures thereof.

The geopolymer as defined above is, according to the invention, macroporous, mesoporous and microporous, and it generally has a density less than 1.5 g/cm³, particularly less than 1.2 g/cm³, in particular less than 0.9 g/cm³, and more specifically less than 0.6 g/cm³.

The term “macroporous geopolymer” denotes a geopolymer having macropores; the term “mesoporous geopolymer” denotes a geopolymer having mesopores; and the term “microporous geopolymer” denotes a geopolymer having micropores.

According to the present invention, the term “macropores” denotes pores wherein the average size, generally defined by the diameter of the cross-section thereof – because pores generally have a circular cross-section – is greater than 500 Å; the term “mesopores” denotes pores wherein the average size is from 20 to 500 Å; and the term “micropores” denotes pores wherein the average size is less than 20 Å, for example is from 5 to 10 Å. Note than one nm = 10 Å.

The mesoporosity is typically between 20 and 33% by volume in relation to the total porosity of the geopolymer.

The geopolymer forming the matrix, skeleton of the material according to the invention also comprises macropores defined in said skeleton, said matrix.

The macroporosity is typically between 20 and 80% by volume in relation to the total porosity of the geopolymer.

The porosity can be measured by nitrogen adsorption-desorption or by mercury intrusion.

The microporosity is typically less than 15% and especially less than 10% and, in particular, between 5 and 10% by volume in relation to the total porosity of the geopolymer.

In the geopolymer, the total porosity corresponding to the macroporosity, the mesoporosity, and the microporosity is greater than 70%, especially greater than 75%, and, in particular, greater than 80% by volume in relation to the total volume of the geopolymer.

The material according to the invention is a solid material having an open multiple (that is to say with a macroporosity, a microporosity and a mesoporosity) and at least partially or even totally, fully interconnected porosity also referred to as a material having an open hierarchical and at least partially or totally interconnected porosity.

More precisely, the material according to the invention has an open and connected (or interconnected) porosity.

According to the invention, this porosity is multiple, i.e. it simultaneously comprises a macroporosity, microporosity and mesoporosity.

This porosity is also open i.e. accessible for a fluid such as an effluent placed in contact with the material. This porosity is also at least partially connected (or interconnected), or even fully interconnected, i.e. the fluid can pass through the material via the interconnected pores. This porosity also enables access to the particles.

The concept of open porosity applies to all pore sizes of the material, that is to say to the mesopores, micropores and mesopores. The pores (macropores, micropores and mesopores) are open and are all at least partially connected, interconnected to one another, or even fully connected, interconnected to one another regardless of their sizes.

Thus, the macropores can be connected to one another and with mesopores and/or micropores, mesopores can be connected to one another and with micropores and/or macropores, and micropores can be connected to one another and with macropores and/or mesopores.

It is not solely the presence of micropores and mesopores which induces the opening and interconnection of the macropores. Two macropores can be interconnected with one another.

To summarize, macropores interconnection is independent of the presence of mesopores and micropores.

Surprisingly, it was observed that, due to the presence in the material according to the invention of particles, particularly active particles, macropores interconnection was enhanced greatly compared to the same material but not comprising particles and that, furthermore, the material according to the invention did not comprise partially closed alveolar macropores unlike the same material but without particles (see examples).

Advantageously, the geopolymer used within the scope of the present invention has percolating macropores which connect a first main surface of the geopolymer material to a second main surface of the material.

According to the present invention, the term “main surface” denotes an external part of the material, which limits it in relation to the environment thereof. The main surface(s) typically has (have) cavities, particularly macroscopic, unobstructed cavities.

The material according to the invention has a specific structure which has never been described or suggested in the prior art, and it furthermore consists of specific materials, namely, especially, a geopolymer which constitutes the skeleton, the matrix of the material according to the invention.

The material according to the invention further comprises particles of at least one solid compound different from the geopolymer, such as active particles, accessible in this matrix.

According to the invention, besides the mere presence of the particles of at least one solid compound different from the geopolymer, such as active particles, it is importantly possible to choose the nature and size of the particles of at least one solid compound different from the geopolymer with virtually no limit and independently of the geopolymer matrix.

Indeed, the material according to the invention may firstly be defined as a material having a multiple porosity or hierarchical porosity or as a material having different scales of porosity, more specifically with three scales of porosity, with a matrix or skeleton in which at least partially interconnected open macropores (in other words an open and at least partially interconnected macroporosity) delimited by microporous and mesoporous sides (surfaces, faces) or walls are defined. The material according to the invention therefore comprises the combination of a macroporosity, a mesoporosity and a microporosity. Moreover, in the material according to the invention, the macropores are open and at least partially interconnected, or even fully interconnected, and do not have a purely alveolar structure, and this is due, surprisingly, to the presence of particles of at least one solid compound different from the geopolymer in the material according to the invention.

In the material according to the invention, the open, interconnected macropores enable the transport of a fluid such as an effluent in the material, and the mesopores and micropores that are themselves open and interconnected ensure that the particles of at least one solid compound different from the geopolymer are readily accessible if these particles are located inside the walls, sides of the macropores.

In other words, the multiporosity and interconnectivity between the macropores make it possible to optimise the transport of a fluid, such as an effluent within the material and the accessibility to the particles very favourably.

It should be noted that a good interconnection can lead to good accessibility of the particles of at least one solid compound different from the geopolymer, but not systematically. It would thus be possible to obtain a substantial interconnection of the macropores but with particles entirely embedded and agglomerated in the walls, sides. If the walls, sides were neither mesoporous nor microporous, these particles would therefore be inaccessible and the material would not be satisfactory. In the material according to the invention, thanks to the open and interconnected micropores and mesopores, especially with the macropores, good accessibility of the particles is always obtained.

The mechanical strength of the material according to the invention is ensured by the geopolymer skeleton (generally aluminosilicate) which is mechanically very robust.

Overall, a geopolymer matrix has numerous advantages compared to a metal oxide matrix.

The synthesis of a geopolymer is simpler to control than the synthesis of a metal oxide by the sol-gel process.

The synthesis of a geopolymer requires less expensive precursors than those used to synthesise metal oxides (mainly alkoxides).

A geopolymer matrix has a superior mechanical strength than a metal oxide matrix.

A geopolymer matrix includes mesopores, while a metal oxide matrix does not include any. To create mesoporosity in a metal oxide, it is necessary to add an additional compound in the emulsion formulation and therefore to make the system more complex.

Finally, to summarize, the material according to the invention has a hierarchical porosity, is mechanically robust and incorporates particles, generally active particles (for example for a specific application in the context of treating fluids such as liquid or gas effluents) with enhanced accessibility of the fluid such as an effluent to be treated to the particles distributed in the material especially due to the existing interconnectivity between the macropores.

In other words, the material according to the invention has an open and interconnected macroporosity, with insertion of particles of at least one solid compound different from the geopolymer, and these particles are accessible.

Advantageously, the material according to the invention may be in the form of particles (in this case, these are not particles of at least one solid compound different, distinct, separate from the geopolymer) such as grains, granules, or beads; or in the form of a monolith.

The material particles or the monolith may have a size (generally defined by the greatest dimension thereof, such as the diameter thereof) of 300 microns (µm) to a ten or several tens of cm, for example 10, 10, 30, 40, 50, or even 100 cm.

The term size thus generally denotes the greatest dimension of the material particles or of the monolith.

A size of 300 to 500 microns is particularly suitable for use in a fixed bed by packing a column.

According to the present invention, the term monolith denotes a solid object of which the average size is at least 1 mm.

Advantageously, the particles of at least one solid compound different from the geopolymer may have an average mean size, such as a diameter, from 2 nm to 100 µm, preferably from 10 nm to 10 µm.

The term size also denotes here the greatest dimension of the particles of at least one solid compound different from the geopolymer such as the diameter.

The size of the particles of at least one solid compound different from the geopolymer may be chosen for a specific target application.

Advantageously, the particles of at least one solid compound different from the geopolymer may be chosen among the group consisting of nanometric particles, submicronic particles, and micronic particles.

According to the present invention, the term “nanometric particles” denotes particles of which the average size, generally defined by the diameter thereof, is from 2 to 100 nm; the term “submicronic particles” denotes particles of which the mean size, generally defined by the diameter thereof is from 100 nm to 1 µm; and the term “micronic particles” denotes particles of which the average size, generally defined by the diameter thereof is from 1 to 100 µm.

The particles of at least one solid compound different from the geopolymer may be entirely inorganic, mineral particles, that is to say particles consisting only, solely (100%) of one or more inorganic solid compound(s).

The particles of at least one solid compound different from the geopolymer may be partially organic particles, that is to say particles comprising one or more inorganic solid particle(s), one or more organic solid compound(s), this is the case in particular of “MOF” particles (see below).

Advantageously, the particles of at least one solid compound different from the geopolymer may be particles of an active compound, or merely active particles.

The term “active particles” or particles of an active compound generally denotes (as opposed to inert particles) particles capable of acting in a chemical, physical, or physicochemical process such as a chemical reaction, sorption phenomena, catalytic processes, etc., for example in catalysis or extraction, for the treatment especially of liquid or gaseous effluents.

Preferably, these active particles are chosen in the group consisting of particles of at least one solid metal cation exchanger compound, catalyst particles, and adsorbent compounds particles.

Advantageously, the solid metal cation exchanger compound may be chosen among the group consisting of zeolites; alkaline silicotitanates; coordination polymer (Metal-Organic Frameworks) particles, and mixtures thereof.

There is no restriction on the shape of the particles of at least one solid compound different from the geopolymer.

Advantageously, the particles of at least one solid compound different from the geopolymer may have the shape of a sphere or of a spheroid, or an acicular shape.

Advantageously, the content of particles of at least one solid compound different from the geopolymer is from 0.1 to 30% by mass, preferably from 5 to 15% by mass of the total mass of the material.

The second aim described above is achieved according to the invention by a method for preparing the material according to the invention as described above.

This preparation method comprises at least the following successive steps:
a) preparing, by mechanical stirring with shearing of a mixture comprising an oily phase and an aqueous phase, an oil-in-water emulsion formed of droplets of the oily phase dispersed in the continuous aqueous phase, the aqueous phase comprising an activation solution, an aluminosilicate source capable of forming a geopolymer by dissolution/polycondensation (of the aluminosilicate source in the activation solution) and optionally a surfactant, and particles of at least one solid compound (different, distinct, separate from the geopolymer) being present at the interface formed by the continuous aqueous phase and the droplets of the oily phase dispersed in the continuous aqueous phase of the emulsion;
b) leaving the emulsion to stand, rest and forming it and shaping it to obtain a chosen size and shape, and the geopolymer matrix is formed by polycondensation;
c) removing the oily phase, and thus obtaining the material according to the invention as described above.

Advantageously, the emulsion is formed and shaped in a mould of chosen size and shape.

The method according to the invention includes a specific sequence of specific steps which has never been described or suggested in the prior art, as represented especially by the documents cited above.

The method according to the invention enables the synthesis, preparation, of the material according to the invention, i.e. a material having a hierarchical porosity, that is mechanically robust and incorporating particles, especially, active particles (for example active particles which have a specific application in the context of treating liquid or gaseous effluents), with enhanced accessibility of the particles, to the fluid such as an effluent to be treated.

The method according to the invention enables the synthesis of said material with a controlled shape and size, ranging for example from one millimetre to several tens of centimetres (see above), without a grinding or compaction step subsequent to synthesis.

Importantly, it is important to note that the method according to the invention enables the synthesis of the material without any restriction of any kind on the size and shape thereof.

Thus, it is, for example, only the size of the mould which can be used during step b) which will limit the size of the shaped final material, in other words of the object consisting of the material.

The method according to the invention is especially characterised by the use of the reagents required for the synthesis of an inorganic binder, based on geopolymer, inside, within the continuous phase of an emulsion comprising particles of at least one solid compound different from the geopolymer, such as active particles.

The method for preparing the emulsion is, according to the invention, optimised, especially to enable a better interconnectivity between the macropores of the geopolymer skeleton and therefore better accessibility of a fluid circulating in the material to the active particles.

According to the invention, in a novel and unexpected manner, an emulsion having as a continuous phase an aqueous activation solution of a geopolymer is stabilised using particles of at least one solid compound different from the geopolymer, such as active particles, and optionally a surfactant, as well as a protocol comprising at least one sequence, for example 2 homogenisation sequences.

The latter two parameters (that is to say, stabilisation using particles, and optionally a surfactant, and protocol comprising at least one homogenisation sequence) enable the formation of pores, especially of macropores, that are non-alveolar and better interconnected enabling better access to the active particles.

In other words, in the method according to the invention, during step a), an oil-in-water emulsion is prepared, more specifically an oily phase dispersed in a continuous aqueous phase, this aqueous phase comprising an activation solution, and an aluminosilicate source capable of forming the geopolymer by dissolution/polycondensation. This emulsion is stabilised in the presence of particles of at least one solid compound different from the geopolymer, especially of active particles. Adding a surfactant capable of acting synergistically with the particles to stabilise the emulsion is sometimes necessary.

Controlling the parameters of this emulsion, and particularly controlling the size of the oil droplets, through the control of the different steps of the method (including steps a3) and a4) described below), makes it possible to control the final porosity of the material.

Inserting an aluminosilicate source makes it possible to obtain a geopolymer type inorganic binder in the aqueous phase of the emulsion by a dissolution-polycondensation process.

The emulsion prepared in step a) generally comprises from 40% vol. to 80% vol., preferably from 50% vol. to 60% vol. of oily phase with respect to the total volume of the emulsion.

The solid particle concentration in the emulsion can be from 0.05% by mass to 20% by mass, preferably from 1% by mass to 10% by mass.

The oily phase of the mixture generally consists of one or more oil(s). The term “oil” is well-known to the man skilled in the art in this technical field and is widely used.

The method according to the invention can be successfully carried out with any type of oil.

Advantageously, the oily phase of the mixture generally consists of one or more linear or branched alkanes having from 7 to 22 carbon atoms, preferably from 12 to 16 carbon atoms, such as dodecane and hexadecane.

Preferably, the oily phase of the mixture consists of dodecane.

The mechanical stirring performed in step a) is a mechanical stirring with shearing.

Advantageously, the shear rate may range from 1000 to 20000 rpm, preferably from 2000 to 15000 rpm, more preferably the shear rate can be 10000 rpm.

The size of the macroporosity of the material may be controlled by acting upon the shear rate of the emulsion. The size of the macroporosity decreases when the shear rate increases.

The mechanical stirring with shearing (mechanical stirring goes together with shearing) carried out during step a) can be carried out by different methods, each of these methods making it possible to obtain a specific porosity. Indeed, a greater shear rate will induce the formation of smaller macropores than for lower shear rates. Thus, the shearing of the emulsion can be mechanical shearing using a homogeniser, or shearing by sonication using ultrasounds.

Preferably, the mechanical stirring with shearing carried out during step a) is carried out using an apparatus intended for emulsifying such as an Ultraturrax® disperser-homogeniser type apparatus. Step a) can be described as a step of emulsifying the mixture described above.

In other words, the term mechanical stirring with shearing generally denotes mechanical stirring which uses a stirring device equipped with an impeller rod or, preferably, a homogenising or dispersion device (for example Ultra-Turrax, IKA® type) capable of being equipped with a dispersion rod having a rotor/stator system.

As already specified above, advantageously, the shear rate set by the homogenising or dispersion device can range from 1000 to 20000 rpm, preferably from 2000 to 15000 rpm, more preferably the shear rate can be 10000 rpm.

The expression “aluminosilicate source” and the expression “reagent material essentially containing silica and aluminium” are, in the present invention, similar and can be used interchangeably.

The reagent material essentially containing silica and aluminium that can be used to prepare the geopolymer matrix of the material according to the invention is advantageously a solid source containing amorphous aluminosilicates. These aluminosilicates are especially chosen among natural aluminosilicate minerals such as illite, stilbite, kaolinite, pyrophyllite, andalusite, bentonite, kyanite, milanite, grovenite, amesite, cordierite, feldspar, allophane, etc.; calcined natural aluminosilicate minerals such as metakaolin; synthetic glasses based on pure aluminosilicates; aluminous cement; pumice; calcined by-products or residue from industrial processing such as fly ash or blast-furnace slags, respectively obtained from coal combustion and when converting iron ore into cast iron in a blast furnace; and mixtures thereof.

The term “activation solution” denotes the high-pH saline solution well-known in the field of geopolymerisation. The latter is a strongly alkaline aqueous solution which may optionally containing silicate compounds especially chosen in the group consisting of silica, colloidal silica and vitreous silica.

The expressions “activation solution”, “high-pH saline solution” and “strongly alkaline solution” are, in the present invention, similar and can be used interchangeably.

The term “strongly alkaline” or “high pH” denotes a solution wherein the pH is greater than 9, especially greater than 10, in particular, greater than 11 and, more particularly, greater than 12. In other words, the activation solution has an OH⁻ concentration greater than 0.01 M, especially greater than 0.1 M, in particular greater than 1 M and, more particularly, between 5 and 20 M.

The activation solution comprises the compensation cation or the mixture of compensation cations as defined above in the form of an ionic solution or a salt. Thus, the activation solution is especially chosen among an aqueous solution of sodium silicate (Na₂SiO₃), potassium silicate (K₂SiO₂), sodium hydroxide (NaOH), potassium hydroxide (KOH), calcium hydroxide (Ca(OH)₂), caesium hydroxide (CsOH) and derivatives thereof, etc.

During step b), the emulsion is left to stand, rest so that the geopolymer skeleton can be formed by polycondensation in the continuous phase of the emulsion.

During this rest, stand step, the size and the shape of the final material are then defined thanks to the workability of the synthesised emulsion. Thus, according to the workability of the emulsion, monoliths, beads or grains can be obtained.

The term “workability” denotes the capability of the emulsion of being formed and shaped (using a mould for example) during a certain time interval before the hardening forming the final material, i.e. when the emulsion has an appearance that is still liquid, or gelled, before hardening and forming the material.

This step may be carried out by leaving the emulsion obtained in step b) to stand at a temperature of 10 to 60° C., for example at a temperature of 40° C. for a sufficient time so that the material according to the invention is formed. This time can be for example from 2 hours to 3 weeks, for example from 24 hours to 7 days.

During step c), the oily phase, still present in the pores of the material, is removed.

The oily phase may be removed by any technique known to the man skilled in the art.

The oily phase may especially be removed by washing, for example in a Soxhlet extractor, followed by drying, by a treatment with a supercritical fluid, such as supercritical CO₂, by a hydrothermal treatment, by a heat treatment, or by a combination of these different treatments.

Washing makes it possible to remove the organic residues from the oily phase and which are essentially found in the macropores.

This washing can be carried out with an organic solvent such as THF, acetone and the mixtures thereof, for example a THF-acetone mixture, preferably a 50-50 mixture of THF and acetone.

This washing can be carried out for a duration of 12 to 36 hours, for example 24 hours.

Preferably, this washing is carried out by bringing the organic solvent to reflux.

The drying can be carried out by allowing the organic solvent used for washing to evaporate at ambient temperature for a duration generally of 5 to 10 days, for example 7 days.

Alternatively, the drying can be carried out with heating for example to a temperature of 90° C.

The drying can also be performed using a supercritical fluid, such as supercritical CO₂.

With the method according to the invention, the material according to the invention is obtained, that is to say a macroporous material (wherein the macroporosity is generated by the oily phase), comprising particles, preferably active particles, especially, nanometric, submicronic or micronic particles which are especially used for stabilising the emulsion (but also for the sought application of the material), optionally with the synergistic aid of a surfactant). The porosity, the mechanical strength – provided by the geopolymer skeleton of the material – the shape and size of the material, the nature and size of the active sizes are thus controlled at the same time.

This method is simple to carry out, and easy to transpose industrially.

To summarize, the advantages and unexpected effects of the method according to the invention, for manufacturing, preparing the material according to the invention, that is to say a material having a multiple porosity comprising active particles are, inter alia, listed below. Some of these advantages of the method are advantages associated with the material that the method makes it possible to obtain and which have essentially already been described above:

The multiporosity and interconnectivity between the macropores are fully controlled by controlling the emulsion (the size of the oil drops in particular), thus making it possible to optimise the transport properties of a fluid, such as an effluent, within the material and the accessibility of the fluid to the active particles

The mesoporosity and the microporosity of the geopolymer matrix ensure increased accessibility to the active particles capable of being incorporated in the core of the walls, sides of the macropores of the material.

The mechanical strength of the final material is ensured by the robust aluminosilicate geopolymer skeleton.

It is extremely important to note that, the method according to the invention can be implemented, with any type of particle, especially with active particle, regardless of the nature thereof, size thereof, especially from 2 nm to 100 µm, preferably from 10 nm to 10 µm, and the particle size distribution thereof, which can just as well be nanometric, as submicronic or even micronic.

For this, it is merely necessary to adapt the parameters for obtaining and stabilising the starting emulsion.

The size of the active sites corresponds directly to the size of the particles incorporated in the formulation of the material according to the invention (nanometric, submicronic or micronic) and which are obtained elsewhere.

The size of the shaped final material obtained is fully modular and is dependent for example on the mould wherein step b) takes place.

The method according to the invention is carried out under mild conditions, at low temperatures, generally at ambient temperature and at atmospheric pressure. The method according to the invention uses inexpensive and non-toxic reagents, especially for the activation solution and the aluminosilicate source. The reaction media are essentially aqueous.

The method according to the invention is simple, reliable, and easy to implement, it makes use of reagents that are readily available at a low cost. It can be carried out with a simple installation and apparatuses. In particular, the method according to the invention is a method of which all of the step (including steps a3) and a4) described below), can be carried out in a single reactor. In other words, the method according to the invention may be described as a “one-pot” method.

Thus, step b) may be carried out in a single reactor, vessel which is the same reactor as that used in step a) if the vessel, reactor, used to produce the emulsion during step a) is used as a mould subsequently, during step b) and step c).

The method according to the invention is easy to transpose to an industrial scale.

Advantageously, prior to step a), the following substeps a1) to a4) are carried out to prepare the mixture comprising an oily phase and an aqueous phase:
a1) preparing an aqueous solution of particles, preferably of active particles, of at least one solid compound (different, distinct, separate from the geopolymer), in water or in an aqueous solution comprising a surfactant;
a2) adding an oily phase to the aqueous suspension of particles obtained at the end of step a1) whereby a biphasic mixture comprising the oily phase and an aqueous phase consisting of the aqueous suspension is obtained;
a3) adding an aqueous activation solution (alkaline silicate) to the aqueous phase of the biphasic mixture obtained at the end of step a2);
a4) adding an aluminosilicate source capable of forming the geopolymer by dissolution/polycondensation, to the aqueous phase of the biphasic mixture obtained at the end of step a3).

Generally, the aqueous suspension of particles prepared in step a1), has a particle concentration from 2 g/L to 1000 g/L.

The concentration of particles in the suspension is chosen according to the final concentration of particles of at least one solid compound different from the geopolymer sought in the prepared material.

The surfactant may be chosen from anionic, cationic, non-ionic surfactants, and mixtures thereof. An example of a surfactant is Tetradecyltrimethylammonium Bromide (TTAB).

The surfactant concentration in the aqueous suspension prepared in step a1) is generally from 0.1% to 20% by mass with respect to the mass of the particles.

Advantageously, following step a2), and before step a3), the biphasic mixture comprising the oily phase and an aqueous phase consisting the aqueous suspension undergoes mechanical stirring with shearing; and/or following step a3) and before step a4), the biphasic mixture undergoes mechanical stirring with shearing.

This mechanical stirring with shearing has already been described in detail above.

The invention also relates to the use of the material according to the invention for catalysing chemical reactions, for filtering a fluid, or for separating or extracting substances contained in a fluid. This fluid may be in any physical state, particularly in a liquid or gaseous state.

The material according to the invention may be used particularly, but not exclusively, in a method for separating at least one metal cation or metalloid cation from a liquid medium containing it, wherein said liquid medium is placed in contact with the material according to the invention.

This medium may be a liquid or gaseous medium.

The materials according to the invention, due to the excellent properties thereof such as an excellent exchange capacity, excellent selectivity, a high reaction rate, are particularly suitable for such a use.

This excellent effectiveness is obtained with reduced quantities of active particles, for example of particles of an inorganic solid metal cation exchanger compound such as a zeolite.

Furthermore, the excellent mechanical strength and mechanical stability properties of the material according to the invention, resulting from the specific structure thereof enable the conditioning thereof in a column and the continuous implementation of the separation method, which can thus be readily incorporated in an existing installation, for example in a treatment chain or line comprising several steps.

Advantageously, said liquid medium may be an aqueous liquid medium, such as an aqueous solution.

Said liquid medium may be a process liquid or an industrial effluent.

Advantageously, said liquid medium may be chosen among liquids and effluents obtained from nuclear industry and installations, and activities using radionuclides.

Generally, said cation may be present at a concentration from 0.1 picogram to 500 mg/L, preferably from 0.1 picogram to 100 mg/L.

The term “metal” also covers the isotopes and especially the radioactive isotopes of said metal, and the term “metalloid” also covers the isotopes and especially the radioactive isotopes of said metalloid.

Advantageously, the cation may be a cation of an element chosen among alkali metals, alkaline-earth metals, transition metals, heavy metals, rare earths (scandium, yttrium and lanthanides), actinides, rare gases, and isotopes, particularly radioactive isotopes, thereof.

Zeolites are particularly well suited for separating such cations.

For example, the cation may be a cation of an element chosen from Sr, Cs, Co, Ag, Ru, Fe and Tl and isotopes, particularly radioactive isotopes thereof.

In particular, the cation may be a cation of ¹³⁴Cs, or of ¹³⁷Cs, or of ⁹⁰Sr.

This method has all the advantages intrinsically associated with the material according to the invention, used in the method, and which were already described above.

The invention will now be described in more detail hereinafter, in conjunction particularly with the specific embodiments thereof which are the subject of examples.

### BRIEF DESCRIPTION OF THE DRAWINGS

[FIG. 1] is an image taken with a Scanning Electron Microscope (SEM) of the submicronic particles of zeolite LTA prepared in example 1.

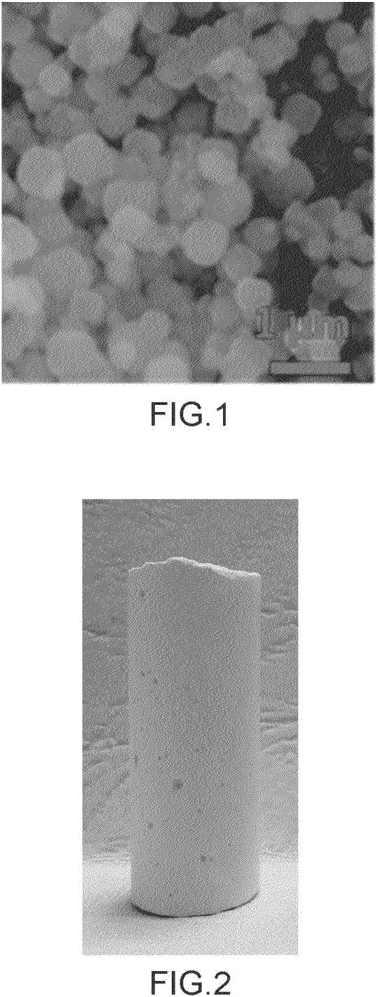

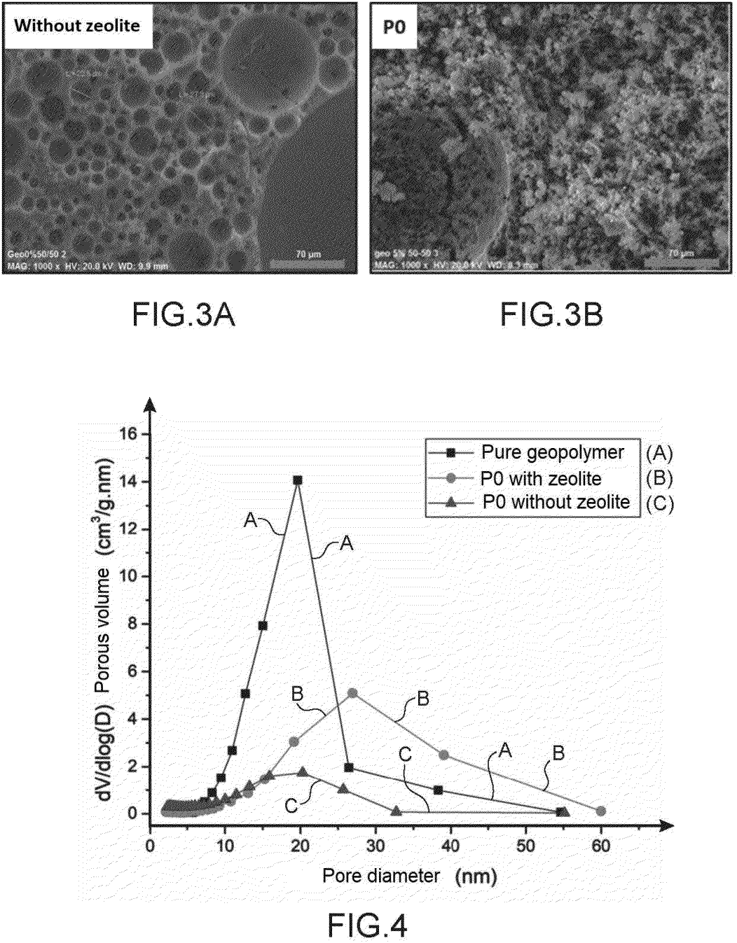

The scale applied in FIG. 1 represents 1 µm.

[FIG. 2] is a photograph of the monolith, comprising a geopolymer incorporating submicronic particles of zeolite LTA, prepared in example 1 using the protocol P0.

[FIG. 3A] and

[FIG. 3B] show SEM images of the inside of the monoliths prepared in example 1 and in example 1A respectively.

The scale applied in FIGS. 3A and 3B represents 70 µm.

[FIG. 4] is a graph which shows the pore size distribution in a pure synthesised geopolymer (Example 1B) (curve A), and in two geopolymers synthesised with P0 with zeolite (Example 1) (curve B), and with P0 without zeolite (Example 1A) (curve C).

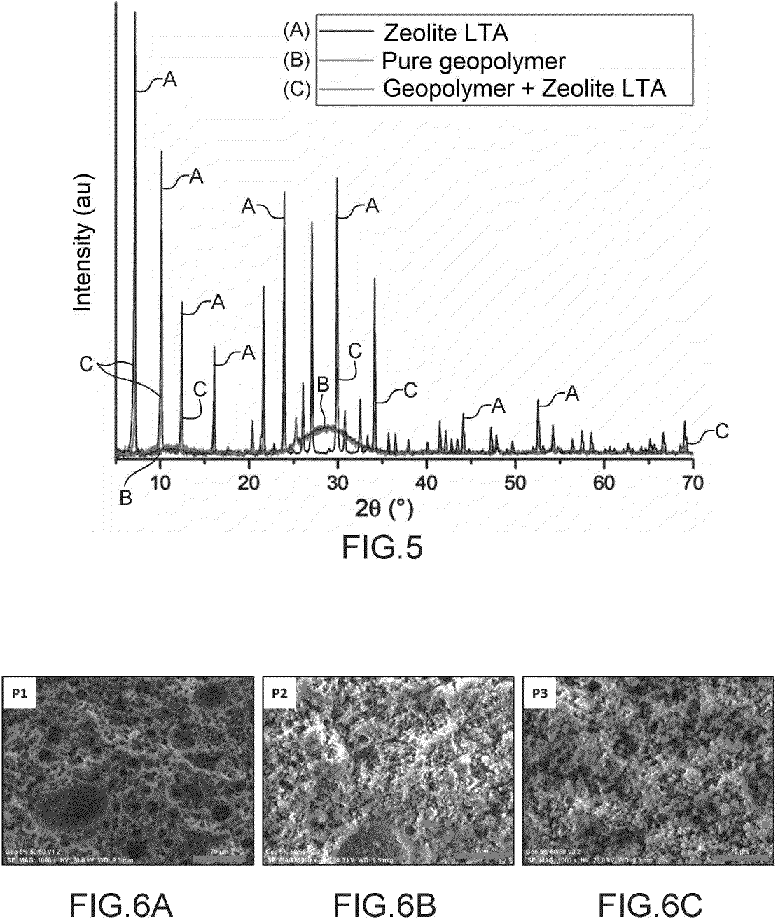

The x-axis shows the pore diameter (in nm) and the y-axis shows dV/dlog(D) Porous volume (in cm³/g.nm).

[FIG. 5] is a graph showing the diffractograms of submicronic zeolite LTA (curve A), of a geopolymer without zeolite synthesised with P0 (Example 1A) (curve B) and of a geopolymer including zeolite LTA synthesised with P0 (Example 1) (curve C).

The x-axis shows 2 theta (in °) and the y-axis shows the intensity (in arbitrary units).

[FIG. 6A] [FIG. 6B] and [FIG. 6C] show SEM images of the geopolymer monoliths prepared in example 2, according to protocol P1 (FIG. 6A), protocol P2 (FIG. 6B) and protocol P3 (FIG. 6C). The scale applied in FIGS. 6A, 6B and 6C represents 70 µm.

[FIG. 7] is a graph showing the pore size distribution in the monoliths prepared in example 2 with protocols P1, P2 and P3.

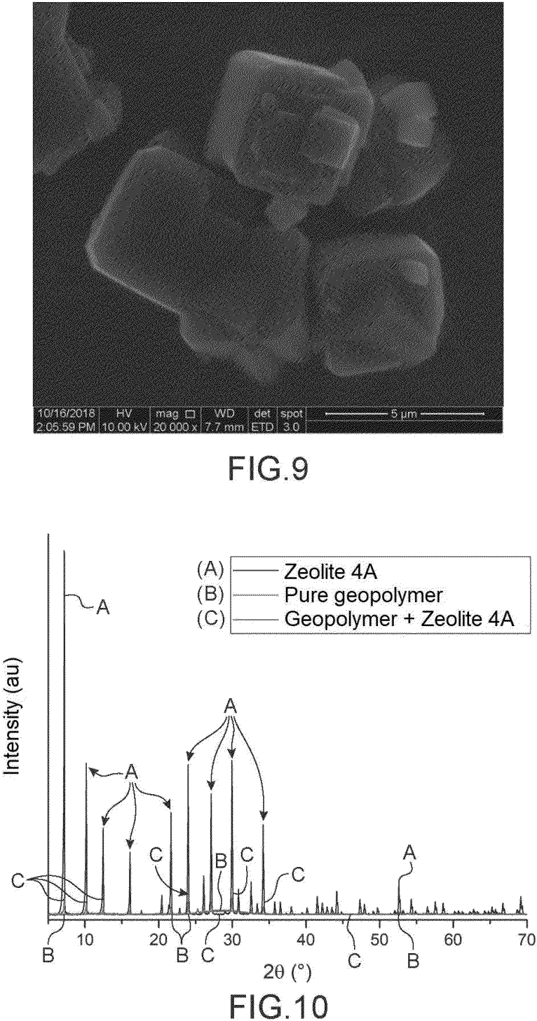

The x-axis shows the pore diameter (in nm) and the y-axis shows dV/dlog(D) Porous volume (in cm³/g.nm).

[FIG. 8] is a bar graph showing the values of Kd (in mL/g) (example 3) determined for a geopolymer zeolite (without submicronic zeolite particles) prepared according to protocol P0, and for geopolymer monoliths, (comprising zeolite particles) prepared according to protocols P0, P1, P2 and P3.

[FIG. 9] is an SEM image of the micronic zeolite particles used in example 4.

The scale applied in FIG. 9 represents 5 µm.

[FIG. 10] is a graph showing the diffractograms (example 4B) of the micronic particles of zeolite 4A (curve A), of a geopolymer without particles of zeolite 4A prepared according to protocol P3 (curve B), and of a geopolymer including particles of zeolite 4A prepared according to protocol P3 (curve C).

The x-axis shows 2 theta (in °) and the y-axis shows the intensity (in arbitrary units).

[FIG. 11] is a graph showing the particle size distribution analysis of the nanometric particles of CST used in example 5.

The x-axis shows the size (in µm), and the y-axis shows the % (in number).

[FIG. 12] is a graph showing the diffractograms (Example 5B) of nanoparticles of CST (curve A), of a geopolymer without CST prepared according to protocol P3 (curve B) and of a geopolymer including nanoparticles of CST prepared according to protocol P3 (curve C).

[FIG. 13] is a graph showing the nitrogen adsorption isotherm produced on the pure geopolymer. The x-axis shows the relative pressure (P/P°), and the y-axis shows the quantity of nitrogen adsorbed (in cm³/g).

### DETAILED DESCRIPTION OF SPECIFIC EMBODIMENTS

The invention will now be described with reference to the following examples, given by way of illustration and not limitation.

### EXAMPLES

### Example 1

In this example, the manufacture, according to the invention, of a monolithic material comprising a geopolymer incorporating a submicronic zeolite is carried out.

More precisely, in this example, according to the invention, submicronic particles of zeolite LTA (known to be an effective and selective adsorbent of Sr in aqueous medium) are incorporated within a macroporous geopolymer matrix, “skeleton”.

Synthesis of submicronic particles of zeolite LTA.

The protocol for synthesising submicronic particles of zeolite LTA is as follows:
2.65 g of NaOH pellets (marketed by Sigma-Aldrich®), and 5.75 g of NaAlO₂ powder (marketed by VWR®), are dissolved separately in 26.25 mL and 35 mL of water respectively.
The two solutions are then mixed in an autoclave under vigorous stirring for a few minutes.
2 g of SiO₂ powder (Aerosil ® 380 available from Evonik Industries®) is then added in the autoclave, and the autoclave is hermetically sealed.
A heat treatment at 40° C. for 20 h, then at 70° C. for 24 h, is applied.
The powder obtained is finally retrieved by filtration, washed with water, and dried overnight at 80° C.

Submicronic particles of zeolite LTA between 300 and 500 nm in size are finally obtained (see FIG. 1).

Manufacture of the material in the form of a monolith, comprising a geopolymer incorporating the submicronic particles of zeolite LTA.

The protocol for synthesising the material comprising a geopolymer incorporating the submicronic particles of zeolite LTA synthesised as described above is the following protocol P0 and which firstly comprises the successive steps:
Step 1: 617 mg of zeolite LTA powder (consisting of submicronic particles) are added to 1.774 mL of an aqueous solution concentrated to 34.8 g.L⁻¹ with surfactant, that is to say Tetradecyltrimethylammonium Bromide (TTAB) (marketed by Sigma-Aldrich®). The concentrated aqueous solution to which the powder was added is placed for 15 minutes in an ultrasound bath.
Step 2: Addition, to the concentrated aqueous solution to which the powder was added, of 5 mL of oily phase, that is to say dodecane (marketed by Sigma-Aldrich®).
Step 3: Addition of 2.12 mL of a solution composed of 81% by mass of a commercial inorganic binder called Betol® K5020T (available from Wöllner®) based on a modified potassium silicate aqueous solution, and composed of 30% by mass of SiO₂ 18% by mass of K₂O, and 52% by mass of H₂O; and of 19% by mass of KOH (85%, marketed by Sigma-Aldrich®).
Step 4: Addition of 2.64 g of Metakaolin powder (Metamax® from BASF)
So-called “UT” step 5: the mixture is finally sheared for 1 minute using an Ultra-Turrax® homogeniser equipped with an S25N-18G dispersion head at a shear rate of 10000 rpm.

An emulsion is thus obtained, at the end of step 5.

This viscous emulsion is placed in a cylindrical mould of one cm in diameter that is left to stand, rest for 48 h.

After mould release, a solid monolithic cylindrical material of approximately 4 cm in height and 1 cm in diameter is obtained.

This monolithic material is then washed with a Soxhlet extractor with a 50-50 THF-acetone mixture to remove the dodecane, then is left to dry at 80° C.

After 24 h of drying, the solid and robust monolith, having retained the dimensions thereof, is obtained (FIG. 2).

### Example 1A

In this example, a material in the form of a monolith similar to that of example 1, but not including submicronic particles of zeolite LTA, is manufactured. This monolith is synthesised according to the same protocol, called protocol P0, as in example 1.

### Example 1B

In this example, a pure geopolymer (pure synthesised geopolymer) is manufactured, i.e. according to protocol P0, but without submicronic zeolite, without TTAB, and without adding oil to form an emulsion.

The geopolymer obtained has a specific surface area of 71.3 m².g⁻¹.

### Example 1C

In this example, the materials prepared in examples 1, 1A, and 1B are characterised.

The interior of the two monoliths prepared in example 1 and in example 1A is observed by scanning electron microscopy (SEM).

The images obtained are shown in FIGS. 3A and 3B.

It is observed that:
In the absence of zeolite particles, the material has alveolar pores with no (or very little) interconnections.
In the presence of zeolite, the microstructure of the material is completely different. The pores no longer have an alveolar structure and the interconnection thereof is enhanced.

The monoliths prepared in examples 1 and 1A are analysed, by nitrogen adsorption-desorption in order to determine the specific surface area thereof (BET model) and the pore size distribution (< 60 nm, BJH model).

Specific surface areas of 34.4 and 37.8 m².g⁻¹ are measured for the geopolymers respectively with (material of example 1) and without zeolite (material of example 1A).

FIG. 4 shows the mesopore size distributions in both materials.

This figure also represents the mesopore size distribution of the pure geopolymer, prepared in example 1B.

It is observed that the pure synthesised geopolymer (Example 1B) and the material prepared using protocol P0 without zeolite (Example 1A) have pore size distributions centred around 19-20 nm, whereas the material synthesised using protocol P0 with zeolite (Example 1 according to the invention), has a pore size distribution centred around 27 nm.

The presence of zeolite in the formulation is thus capable of increasing the size of the mesopores.

FIG. 13 shows the adsorption isotherm of the pure geopolymer. This isotherm has a type IV shape in the IUPAC classification and demonstrates the presence of micropores in the structure of the geopolymer due to the shape of the curve at low pressures.

The two monoliths prepared in example 1 and in example 1A are then ground in powder form and an X-ray diffraction (XRD) analysis is then performed.

An XRD analysis is also performed on the pure submicronic zeolite LTA powder.

The results of these analyses are shown in FIG. 5.

(NB: in FIG. 5, “pure geopolymer” is mentioned: this is the geopolymer synthesised without submicronic zeolite, without TTAB and without adding oil to form an emulsion (geopolymer of example 1B)).

The 3 diffractograms shown in FIG. 5 demonstrate that the submicronic particles of zeolite LTA have, in the material prepared in example 1, according to the invention, indeed been incorporated in the structure of the macroporous geopolymer.

### Example 1D

In this example, the effectiveness of the material prepared in example 1 according to the invention, and of the material prepared in example 1A for decontaminating effluents containing Strontium (Sr) was studied.

In other words, in this example, the material prepared in example 1 according to the invention, and the material prepared in example 1A were tested in the context of an application as an Sr-adsorbent material.

Sorption tests of Sr in solution are therefore performed to make it possible to validate that the zeolite LTA inserted in the geopolymer skeleton in the material prepared in example 1 is indeed active.

The parameter used to monitor Strontium sorption is Kd (distribution coefficient in mL/g) calculated according to the following formula:

$${K}_{D} = \frac{\left({\left[S r\right]}_{i n i t} - {\left[S r\right]}_{f i n}\right)}{{\left[S r\right]}_{f i n}} \frac{V}{m}$$

In this formula:
[Sr]ᵢₙᵢₜ and [Sr]_{fin} respectively represent the initial and final Sr concentration in solution (mg/L),
V is the solution volume (mL),
m is the material mass (g).

The protocol used for these sorption tests is as follows:
50 mg of material (in monolithic form) are placed in 50 mL of a matrix (aqueous solution) containing 0.05 mol/L of NaNO₃, 50 ppm of Ca (added in the form of the salt Ca(NO₃)₂), 2 ppm of Cs (added in the form of the salt CsNO₃) and 2 ppm of Sr (added in the form of the salt Sr(NO₃)₂).
The whole is stirred with a rotary stirrer for 24 h.
After stirring, 15 ml of supernatant is extracted with a syringe, and this sample is filtered with a 0.22 µm syringe filter, then the residual Sr concentration is analysed by inductively coupled plasma (ICP) spectrometry.

The geopolymer monolith free from zeolite (Example 1A) has a Kd of 1128 mL/g while the geopolymer monolith containing the particles of zeolite LTA (Example 1 according to the invention) has a Kd of 5024 mL/g.

This result demonstrates that the particles of zeolite LTA incorporated in the macroporous geopolymer (Example 1 according to the invention) allow highly improved decontamination, virtually of a factor of 5.

This result clearly shows the accessibility of the zeolite particles by the contaminated effluent.

### Example 2

In this example, a monolithic material comprising a geopolymer incorporating a submicronic zeolite is prepared by various methods in order to study the influence of the manufacturing method on the macroporosity of the monolithic material.

Thus, in order to observe the influence of the manufacturing method on the macroporosity of the material and the interconnectivity of the macropores, one or two additional steps called “UT” steps were added to the different steps of the protocol P0 (called steps 1, 2, 3, 4 and 5 (“UT”) in example 1).

3 new protocols, called protocols P1, P2 and P3, were therefore tested and are described in Table 1 below.

The quantities of material added are similar to those used in example 1. The final materials obtained using protocols P0, P1, P2 and P3 therefore have exactly the same final chemical compositions.

Table 1

Description of the different steps of protocols P1, P2 and P3

| | | |
|---|---|---|
| P1 | P2 | P3 |
| 1, 2, UT, 3, 4, UT | 1, 2, UT, 3, UT, 4, UT | 1, 2, 3, UT, 4, UT |

It is important to note that the description of protocols P0, P1, P2, P3 and P4 given here in the specific context of example 1 and example 2 can be readily generalised and that especially the specific conditions of the different steps can be readily generalised with regard to the “description of the invention” given above.

Regardless of the protocol used, an emulsion is systematically stabilised then placed in a mould and left to stand for 48 h to obtain the setting of the geopolymer skeleton and the formation of a cylindrical monolith of a few centimetres in heights and 1 cm in diameter.

After washing for a 24 h duration in the Soxhlet extractor with a 50-50 THF-acetone mixture to remove the dodecane, the monolith is left to dry for 24 h at 80° C.

The inside of each of the monoliths obtained is then observed by scanning electron microscopy (SEM).

The images obtained are shown in FIGS. 6A, 6B and 6C.

It is observed that:
Protocol P1 (FIG. 6A) produces so-called “alveolar” materials wherein the pores seem to be slightly interconnected.
Protocol P2 (FIG. 6B) generates an intermediate microstructure with alveolar pores residues, as well as the presence of non-alveolar and more interconnected pores.
Protocol P3 (FIG. 6C) produces for its part a large majority of non-alveolar and highly interconnected pores

The monoliths are analysed by nitrogen adsorption-desorption in order to determine the specific surface area thereof (Brunauer, Emmett and Teller model, “BET”) and the pore size distribution thereof (< 60 nm, Barrett, Joyner, Halenda model, “BJH”).

Specific surface areas of 33.1, 30.6 and 31.5 m².g⁻¹ are measured for the materials prepared with protocols P1, P2 and P3 respectively.

FIG. 7 shows the pore size distributions (< 60 nm) in the three materials.

The pore size distribution of each material is centred on 27 nm, like that obtained for the material synthesised using P0 with zeolite.

The modification of the synthesis protocol therefore does not appear to have any influence on the mesopores size distribution.

Thus, these results clearly demonstrate an influence of the inversion of the manufacturing steps on the macroporosity and interconnectivity of the macropores of the material, without modifying the mesoporosity of the walls.

These results show that protocol P3 is the preferred protocol, then, in order, protocol P0 then protocol P2, and finally protocol P1.

### Example 3

In this example, the influence of the manufacturing method on the decontamination effectiveness of the monolithic material comprising a geopolymer containing submicronic zeolite LTA particles is studied.

For this, the effectiveness of the materials prepared according to protocols P1, P2 and P3 for decontaminating effluents containing Strontium was studied.

Similar “batch” studies to those conducted in example 1D were performed.

FIG. 8 shows the Kd values obtained with the materials prepared by protocols P1, P2 and P3.

FIG. 8 also shows the Kd value obtained with the geopolymer monolith without zeolite (prepared in example 1A according to protocol P0), Kd of 1128 mL/g: see example 1C) as well as the Kd value obtained with the geopolymer monolith containing zeolite LTA particles and prepared according to protocol P0 (Example 1 according to the invention, Kd of 5024 mL/g: see example 1D).

In FIG. 8, a clear difference between the Kd values is observed, which is due to the different internal porous microstructures of the materials rendering the active zeolite particles more or less accessible to the effluent to be decontaminated.

Thus:
The materials prepared according to protocols P0 and P3 have non-alveolar and more interconnected microstructures and have higher Kd values.
The material prepared according to protocol P1 has a highly alveolar and less interconnected structure and has a Kd only two times greater than that of the material free from zeolite.
The material prepared according to protocol P2 has an intermediate microstructure, hence inducing an intermediate Kd.

Once again: these results show that protocol P3 is the preferred protocol, then, in order, protocol P0 then protocol P2, and finally protocol P1.

### Example 4

In this example, the manufacture, according to the invention, of a monolithic material comprising a geopolymer incorporating a zeolite of micronic size is carried out.

More precisely, in this example, according to the invention, micronic particles of zeolite 4A (known to be an effective and selective adsorbent of Sr in aqueous medium) are incorporated within a macroporous geopolymer matrix.

The micronic particles of zeolite 4A are commercial particles manufactured by the company CTI (Ceramiques Techniques Industrielles).

FIG. 9 shows an SEM image of these particles, the size of which is between 4 and 5 µm.

Manufacturing protocol P3 (described in example 2) is used, the mass of submicronic zeolite having been replaced by the same mass of micronic zeolite.

A viscous emulsion is thus obtained, at the end of the final step of protocol P3 (step “UT”).

This viscous emulsion is placed in a mould that is left to stand for 48 h.

After mould release, a monolithic material is obtained.

This monolithic material is then washed with a Soxhlet extractor with a 50-50 THF-acetone mixture to remove the dodecane, then it is left to dry at 80° C.

After 24 h of drying, a cylindrical monolith of a few centimetres in height and 1 cm in diameter is obtained.

The monolith is then ground in powder form. An X-ray diffraction (XRD) analysis is then carried out.

### Example 4A

In this example, a material in the form of a monolith similar to that of example 4, but not including micronic particles of zeolite 4A, is manufactured. This monolith is synthesised according to the same protocol, called protocol P3, as in example 4, but without micronic zeolite, without TTAB and without adding oil to form an emulsion.

The monolith is then ground in powder form. An X-ray diffraction (XRD) analysis is then carried out

### Example 4B

In this example, an X-ray diffraction (XRD) analysis of the powders obtained at the end of examples 4 and 4A is carried out.

An XRD analysis is also performed on the micronic zeolite 4A powder.

The results of these XRD analyses are shown in FIG. 10.

(NB: in FIG. 10, “pure geopolymer” is mentioned: this is the geopolymer synthesised without micronic zeolite, without TTAB and without adding oil to form an emulsion (geopolymer of example 4A)).

The three diffractograms shown in FIG. 10 demonstrate that the micronic zeolite 4A particles have indeed been incorporated in the structure of the macroporous geopolymer.

### Example 4C

In this example, the effectiveness of the material prepared in example 4 according to the invention for decontaminating effluents containing Strontium (Sr) was studied.

For this, a similar “batch” test to those conducted in example 1D was performed.

A Kd of 5528 mL/g, greater than the Kd of 1128 mL/g of a geopolymer free from active particles (see example 1D) is obtained, demonstrating the effectiveness of the material.

### Example 5

In this example, the manufacture, according to the invention, of a monolithic material comprising a geopolymer incorporating nanometric crystalline silico-titanate (CST) particles is carried out.

More precisely, in this example, according to the invention, nanometric particles of crystalline silico-titanates (CST) (known to be an effective and selective adsorbent of Sr in aqueous medium) are incorporated within a macroporous geopolymer “skeleton” matrix.

The nanometric CST particles are commercial particles manufactured by the company UOP.

FIG. 11 shows a laser particle size distribution analysis of these particles which shows that the size thereof is between about 10 and 20 nm in solution after dispersion with ultrasounds.

Manufacturing protocol P3 (described in example 2) is used, the mass of submicronic zeolite having been replaced by the same mass of CST.

A viscous emulsion is thus obtained, at the end of the final step of protocol P3 (step “UT”).

This viscous emulsion is placed in a mould that is left to stand for 48 h.

After mould release, a monolithic material is obtained.

This monolithic material is then washed with a Soxhlet extractor with a 50-50 THF-acetone mixture to remove the dodecane, then it is left to dry at 80° C.

After 24 h of drying, a cylindrical monolith of a few centimetres in height and 1 cm in diameter is obtained.

The monolith is then ground in powder form.

### Example 5A

In this example, a material in the form of a monolith similar to that of example 5, but not including nanometric CST particles, is manufactured. This monolith is synthesised according to the same protocol, called protocol P3, as in example 5.

The monolith is then ground in powder form.

### Example 5B

In this example, an X-ray diffraction (XRD) analysis of the powders obtained at the end of examples 5 and 5A is carried out.

An XRD analysis is also performed on the nanometric CST powder.

The results of these XRD analyses are shown in FIG. 12.

(NB: in FIG. 12, pure geopolymer is mentioned: this is a geopolymer synthesised without CST, without TTAB and without adding oil to form an emulsion (geopolymer of example 4A)).

These 3 diffractograms demonstrate that the nanometric CST particles have indeed been incorporated in the structure of the macroporous geopolymer.

### Example 5C

In this example, the effectiveness of the material prepared in example 5 according to the invention for decontaminating effluents containing Strontium (Sr) was studied.

For this, a “batch” test similar to those conducted in example 1D is performed.

A Kd of 4732 mL/g, greater than the Kd of 1128 mL/g of a geopolymer free from active particles (see example 1D) is obtained, demonstrating the effectiveness of the material.

### REFERENCES

[1] FR-A1-2791905.
[2] Didi Y., Said B., Cacciaguerra T., Nguyen K.L., Wernert, V., Denoyel R., Co D., Sebai W., Belleville M.P., Sanchez-Marcano J., Fajula F., Galarneau A., “Synthesis of binderless FAU-X (13X) monoliths with hierarchical porosity”, Microporous and Mesoporous Materials, 281 (2019) 57-65.
[3] Said B., Cacciaguerra T.,Tancert F., Fajula F., Galarneau A., “Size control of self-supported LTA zeolite nanoparticles monoliths”, Microporous and Mesoporous Materials, 227 (2016) 176-190.
[4] WO-A1-2016/0382016.
[5] F. Liguori, P. Barbaro, B. Said, A. Galarneau, V. Dal Santo, E. Passaglia, A. Feis, “Unconventional Pd@Sulfonated Silica Monoliths Catalysts for Selective Partial Hydrogenation Reactions under Continuous Flow” Chemcatchem, 9 (2017) 3245-3258.
[6] FR-A-3035660
[7] FR-A1-3037583.
[8] FR-A1-3015476
[9] WO-A1-2012/049412.

What is claimed is:

1. Solid material having an open multiple and at least partially interconnected porosity, comprising a matrix made of a microporous and mesoporous geopolymer, in which at least partially interconnected open macropores delimited by sides or walls made of microporous and mesoporous geopolymer are defined, and particles of at least one solid compound different from the geopolymer being distributed in the macropores and/or in the sides or walls.

2. Material according to claim 1 which is in the form of particles such as grains, granules, or beads; or in the form of a monolith; especially of from 300 µm to a ten or several tens of cm in size, for example 10, 30, 40, 50, or even 100 cm.

3. Material according to claim 1, wherein the particles of the at least one solid compound different from the geopolymer have an average size, such as a diameter, from 2 nm to 100 µm, preferably from 10 nm to 10 µm.

4. Material according to claim 3, wherein the particles of at least one solid compound different from the geopolymer are chosen among the group consisting of nanometric particles, submicronic particles, and micrometric particles.

5. Material according to claim 1 wherein the particles of at least one solid compound different from the geopolymer are active particles.

6. Material according to claim 5, wherein the active particles are chosen among the group consisting of particles of at least one solid metal cation exchanger compound, catalyst particles, and adsorbent compound particles.

7. Material according to claim 6, wherein the solid metal cation exchanger compound is chosen among the group consisting of zeolites; alkaline silicotitanates; coordination polymer (Metal-Organic Frameworks) particles, and mixtures thereof.

8. Material according to claim 1, wherein the amount of particles of at least one solid compound different from the geopolymer is from 0.1 to 30% by mass, preferably from 5 to 15% by mass of the total mass of the material.

9. Method for preparing the material according to claim 1, which comprises at least the following successive steps:
a) preparing, by mechanical stirring with shearing of a mixture comprising an oily phase and an aqueous phase, an oil-in-water emulsion formed of droplets of the oily phase dispersed in the continuous aqueous phase, the aqueous phase comprising an activation solution, an aluminosilicate source capable of forming a geopolymer by dissolution/polycondensation and optionally a surfactant, and particles of at least one solid compound being present at the interface formed by the continuous aqueous phase and the droplets of the oily phase dispersed in the continuous aqueous phase of the emulsion;
b) leaving the emulsion to stand, and forming it and shaping it to obtain a chosen size and shape, and the geopolymer matrix is formed by polycondensation;
c) removing the oily phase, and thus obtaining the material according to claim 1.

10. Method according to claim 9, wherein the oily phase of the mixture consists of one or more linear or branched alkanes having from 7 to 22 carbon atoms, preferably from 12 to 16 carbon atoms, such as dodecane and hexadecane.

11. Method according to claim 9, wherein, prior to step a), the following successive substeps a1) to a4) are carried out to prepare the mixture comprising an oily phase and an aqueous phase:
a1) preparing an aqueous solution of particles of at least one solid compound, in water or in an aqueous solution comprising a surfactant;
a2) adding an oily phase to the aqueous suspension of particles obtained at the end of step a1), whereby a biphasic mixture comprising the oily phase and an aqueous phase consisting of the aqueous suspension is obtained;
a3) adding an aqueous activation solution to the aqueous phase of the biphasic mixture obtained at the end of step a2);
a4) adding an aluminosilicate source capable of forming the geopolymer by dissolution/polycondensation, to the aqueous phase of the biphasic mixture obtained at the end of step a3).

12. Method according to claim 11, wherein following step a2), and before step a3), the biphasic mixture comprising the oily phase and an aqueous phase consisting of the aqueous suspension undergoes mechanical stirring with shearing; and/or following step a3) and before step a4), the biphasic mixture undergoes mechanical stirring with shearing.

13. Use of the material according to of claim 1, for catalysing chemical reactions, for filtering a fluid, or for separating or extracting substances contained in a fluid.

14. Method for separating at least one metal cation or metalloid cation from a liquid medium containing it, wherein said liquid medium is placed in contact with the material according to claim 1.

15. Method according to claim 14, wherein the liquid medium is an aqueous liquid medium, such as an aqueous solution.

16. Method according to claim 14 , wherein said liquid medium is chosen from liquids and effluents from nuclear industry and installations and activities using radionuclides.

17. Method according to claim 14, wherein said cation is present at a concentration from 0.1 picogram to 500 mg/L, preferably from 0.1 picogram to 100 mg/L.

18. Method according to claim 14, wherein the cation is a cation of an element chosen among alkali metals, alkaline-earth metals, transition metals, heavy metals, rare earths, actinides, rare gases, and isotopes, particularly radioactive isotopes, thereof.

19. Method according to claim 14, wherein the cation is a cation of an element chosen among Sr, Cs, Co, Ag, Ru, Fe and Tl and isotopes, especially radioactive isotopes thereof.

20. Method according to claim 19, wherein the cation is a cation of ¹³⁴Cs, or of ¹³⁷CS, or of ⁹⁰Sr.
